(19) United States
(12) Patent Application Publication
(10) Pub. No.: US 2008/0191369 A1
(43) Pub. Date: Aug. 14, 2008

(54) Carburetor Having A Rotationally Operated Choke

(76) Inventors: Marion W. Reynolds, Anderson, SC (US); John F. Morris, Anderson, SC (US); Anthony S. Thomas, Anderson, SC (US); Roger Klinck, Greer, SC (US); Charles A. Eakins, Liberty, SC (US)

Correspondence Address: TTi/BRINKS HOFER GILSON & LIONE, P.O.BOX 10395, CHICAGO, IL, 60610, US

(21) Appl. No.: 11/673,970

(22) Filed: Feb. 12, 2007

(51) Int. Cl. F02M 7/12

(52) U.S. Cl. 261/64.1; 55/DIG. 28; 261/DIG. 74

(57) ABSTRACT

A carburetor with a housing defining an air intake and fluidly connected to a throttle system is provided. A rotatable choke is connected to the carburetor and includes a plate with an inlet aperture in fluid communication with the air intake. A dial is rotatably mounted to the housing and surrounds a portion of the plate. The dial substantially blocks the inlet aperture when in a first position with respect to the plate, and the dial exposes the inlet aperture when in a second position with respect to the plate.

### BACKGROUND

Carburetors are frequently provided in internal combustion engines to allow for manual or automatic regulation of the amount of fuel that is injected into the combustion chamber of an engine during engine startup and during both normal and transient engine operation. The carburetor normally includes a fuel inlet that is controlled by a throttle valve that may be manually or automatically operated to control the amount of fuel entering the combustion chamber. With increasing amounts of fuel, engine speed and often torque increases.

It is well known in the art that the ratio of fuel and air that enters the combustion chamber must be altered or controlled during different stages of engine operation to provide for reliable engine starting and efficient and reliable operation during steady state and transient situations. A choke is often provided in conjunction with a carburetor to provide either manual or automatic control of the volume of air flowing through the carburetor, which directly influences the fuel/air ratio that enters the combustion cylinder,

At engine startup it is beneficial to inject a very high fuel to air ratio to provide the cylinder with sufficient fuel to be combusted by a spark during the initial compression cycle of the piston. A choke may be provided to allow a user to vary the amount of air flowing through the carburetor to alter the fuel/air ratio as necessary. Accordingly, when an engine is started, the choke is normally placed in a Full Choke position, which substantially eliminates air flow through the carburetor to ensure that the initial combustion occurs.

After the initial few combustion cycles, additional air (and oxygen) must be injected into the cylinder to maintain the combustion cycle. Normally, the choke is moved to a Half Choke position, which allows a partial flow of air to the combustion chamber and accordingly lowers the fuel to air ratio. With continued operation, the engine warms up to normal operating temperature and engine RPMs increase due to a wider opened throttle, additional air is required to maintain the rapid linear oscillation of the piston, and the choke is normally transferred to the Run position, where a full amount of air and fuel is allowed to pass through the carburetor to the combustion chamber.

Many conventional chokes include a rotatable plate that is disposed at the carburetor inlet. Choke plates are normally remotely controlled by the operator (or automatically through a control system) with a mechanical linkage or similar structure. For example, U.S. Pat. No. 5,174,255 discloses a choke with a rotatable knob that is operable by the user to control the position of an internal choke plate through a mechanical linkage. As shown in U.S. Pat. No. 6,135,428, a conventional choke plate is normally rotatable between a position where the choke plate is generally perpendicular to the air flow path through the carburetor, to substantially block air flow through the carburetor, which is often referred to as the Full Choke position. The conventional choke plate may be rotated to a position where the choke plate is substantially parallel to the flow path through the carburetor, where the choke plate blocks a minimal amount of air flow through the carburetor. Some conventional chokes allow the choke plate to be retained at an oblique angle with respect to the flow path through the carburetor, to allow a fraction of the potential air flow through the carburetor. While conventional chokes allow for remote operation of the choke plate to alter the fuel/air mixture entering the combustion chamber, the mechanical linkages or similar structures to selectively rotate and maintain the choke plates are often complicated systems with multiple components, and introduce added cost, complexity, size, and weight to engines.

### SUMMARY

A first representative embodiment of the present invention provides a carburetor with a housing defining an air intake. A first member is provided on the housing that includes an inlet aperture in fluid communication with the air intake, and a second member is rotatably mounted to the housing. The second member substantially blocks the inlet aperture when in a first position with respect to the first member, and the second member exposes the inlet aperture when in a second position with respect to the first member.

A second representative embodiment of the present invention provides a carburetor for an internal combustion engine. The carburetor includes a housing defining an air intake and a first member mounted to the housing. The first member includes an air inlet aperture in fluid communication with the air intake, and a first electrical contact in electrical communication with a spark plug within the engine. A second member is rotatably mounted to the housing and comprising a second electrical contact, wherein the second member is rotatable to a position wherein the first and second contacts are electrically connected.

A third representative embodiment of the present invention provides a choke for use with an internal combustion engine. The choke includes a first member that is mounted to the engine, which includes an inlet aperture in fluid communication with an engine air intake. A second member is rotatably mounted to the engine and at least partially surrounds a portion of the first member and inlet aperture, wherein rotation of the second member with respect to the first member selectively blocks the inlet aperture.

Advantages of the present disclosure will become more apparent to those skilled in the art from the following description of the preferred embodiments of the invention that have been shown and described by way of illustration. As will be realized, the disclosure is capable of other and different embodiments, and its details are capable of modification in various respects. Accordingly, the drawings and description are to be regarded as illustrative in nature and not as restrictive.

### DESCRIPTION OF THE DRAWINGS

FIG. 1 is a perspective view of an internal combustion engine with a rotatable choke.

FIG. 2 is the view of FIG. 1 with the rotatable choke removed.

FIG. 3 is an exploded view of the rotatable choke and carburetor of FIG. 1.

FIG. 4 is a second exploded view of the rotatable choke and carburetor of FIG. 1.

FIG. 5 is a plan view of the plate of the rotatable choke of FIG. 1.

FIG. 6 is a perspective view of the plate of the rotatable choke of FIG. 1.

FIG. 7 is a plan view of an internal surface of the dial of the rotatable choke of FIG. 1.

FIG. 8 is a plan view of a portion of the choke of FIG. 1 in the Full Choke position.

FIG. 9 is the view of FIG. 8 in the Half Choke position.

FIG. 10 is the view of FIG. 8 in the Run Position.

FIG. 11 is an exploded view of an alternate rotatable choke and carburetor.

FIG. 12a is a plan view of the plate and carburetor of FIG. 11 in the Full Choke position.

FIG. 12b is the view of FIG. 12a in the Half Choke position.

FIG. 12c is the view of FIG. 12a in the Run position.

### DESCRIPTION

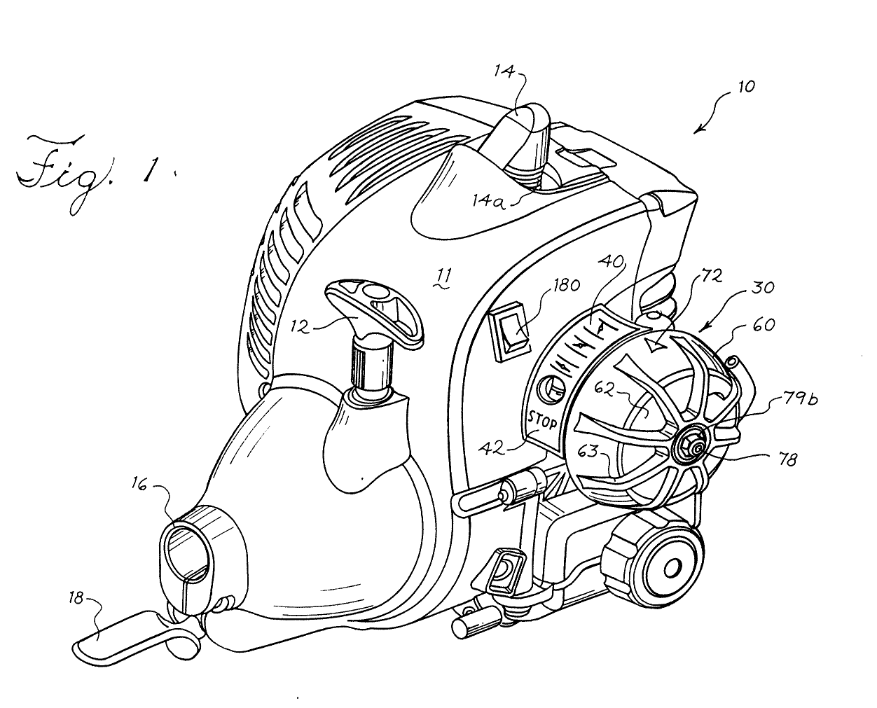

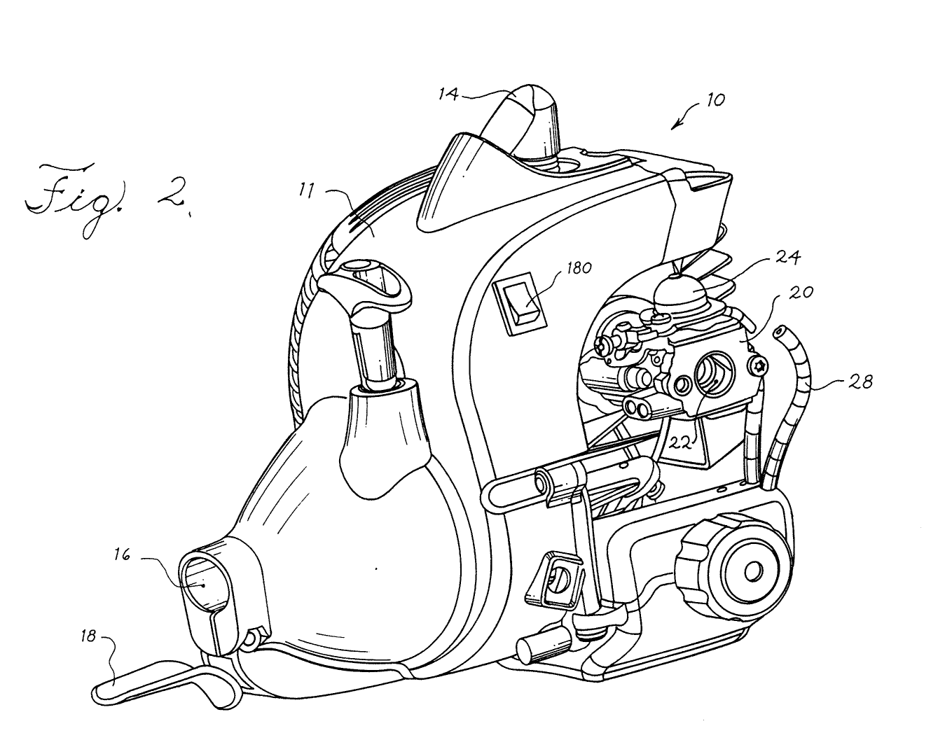

Referring now to the embodiments shown in FIGS. 1-10, a rotatable choke 30 for use with an internal combustion engine 10 is provided. Specifically, the rotatable choke 30 provides for selective inlet air flow into the carburetor 20 of an internal combustion engine 10 based on the position of a rotatable dial 60 with respect to a plate 40 that is fixed to the carburetor 20. The rotatable choke 30 is usable with either two or four cycle internal combustion engines, overhead or side valve engines, and with a wide variety of power tools that use internal combustion engines. For example, the rotatable choke 30 may be used with engines provided on string trimmers, chain saws, blowers, hedge trimmers, or any other similar tool that is used with an internal combustion engine. The rotatable choke 30 may further be used with internal combustion engines on other types of tools such as lawn mowers, snow blowers, pressure washers, generators, and the like.

Generally, an internal combustion engine 10 for use with the rotatable choke 30 includes a housing 11 that encloses the majority of the components of the internal combustion engine 10. The engine additionally includes a piston (not shown) that reciprocatingly moves within a cylinder (not shown), which rotates a crankshaft (not shown) that ultimately provides torque to rotate or otherwise move an output portion of the tool that extends through the working member outlet 16. A variable mixture of air and fuel is injected into the cylinder above the piston, which is ignited by a spark from a spark plug 14a during the piston compression cycle due to the rapid increase in pressure within the cylinder during the compression cycle. The combustion within the cylinder forces the piston downward, allowing the piston to linearly oscillate within the cylinder and the crankshaft to rotate. The cycle continues while additional air, fuel, and sparks are provided within the combustion chamber. The spark plug 14a is electrically connected to a magneto or other type of generator through spark plug 14a wires 14 and a corresponding electrical circuit which provides a surge of current to the spark plug 14a at the appropriate time during the compression cycle.

It is often beneficial to vary the ratio of fuel to air that is injected into the piston cylinder during various times types of engine operation. A carburetor 20 may be provided upstream of the cylinder injection port to vary amount of fuel and air that is injected into the cylinder. The carburetor 20 often includes a primer bulb 24 to allow for manual insertion of fuel to the carburetor 20, a throttle valve and associate throttle control system (not shown) to supply a controlled amount of fuel to the engine, and a choke 30 to allow the operator to vary the amount of air that is entrained with the fuel entering the cylinder. The carburetor includes an air inlet 22, an air outlet 26, and a fuel line 28 that provides a variable amount of fuel to the carburetor 20 between the air inlet 22 and outlet 26.

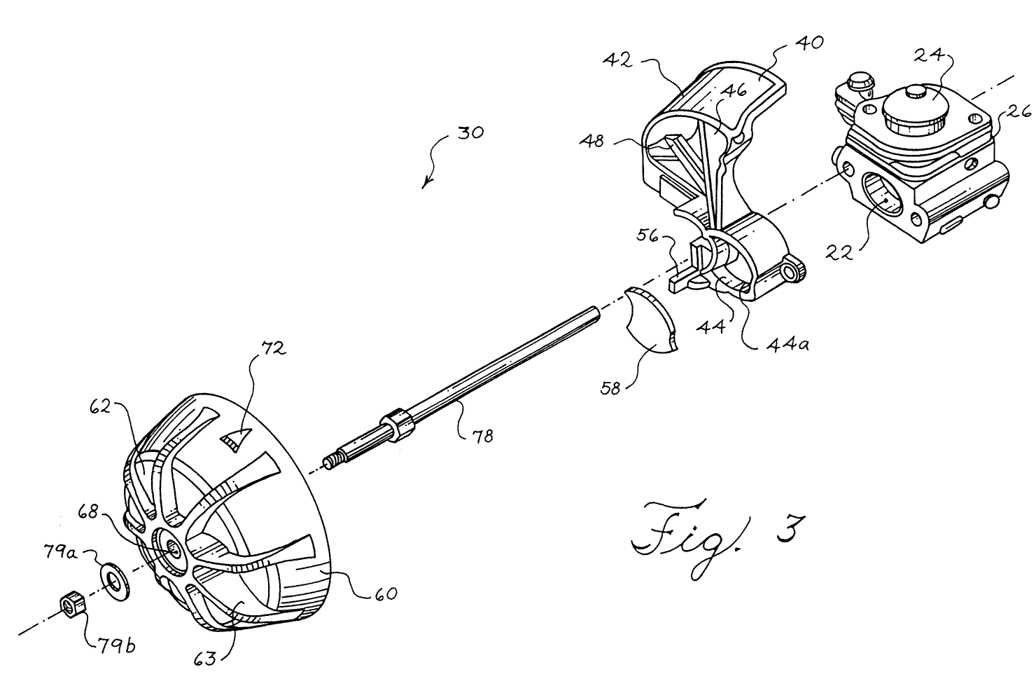

The rotatable choke 30 is provided on the carburetor 20. The choke 30 encloses a portion of the carburetor 20 and selectively opens and closes the air inlet 22 to the carburetor 20. The rotatable choke 30 includes a plate 40 that is fixed to the carburetor 20 and a dial 60 that is rotatably connected to the carburetor 20 and at least partially encloses a portion of the carburetor 20 and the air inlet 22. As best shown in FIG. 3, the plate 40 neighbors the inlet 22 of the carburetor 20 and the dial 60 is rotatably mounted on the opposite side of the plate 40 from the carburetor 20. Rotation of the dial 60 of the choke 30 allows the user to control the fuel/air ratio that flows to the combustion cylinder for proper and efficient control of the internal combustion engine 10.

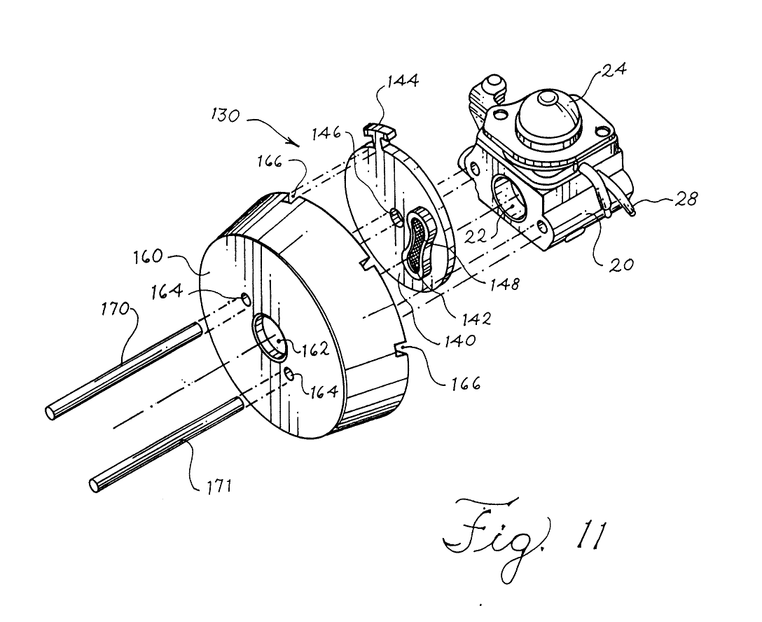

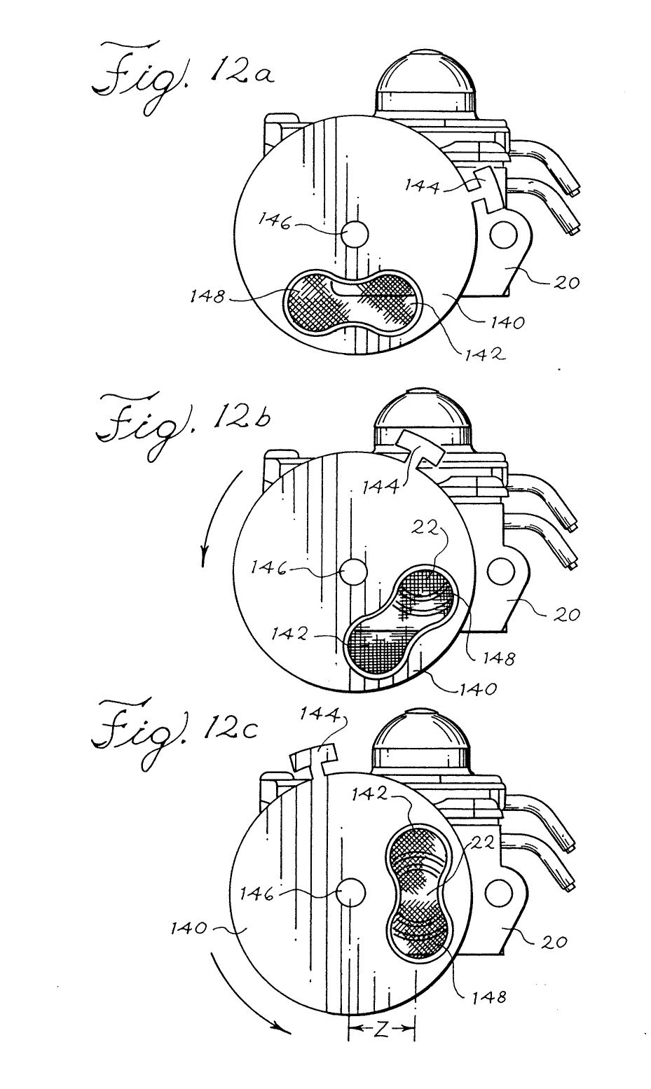

The plate 40 may be a single piece of molded plastic or metal, or another light weight and suitably strong material. Alternatively, the plate 40 may be formed from multiple members rigidly connected together. The plate 40 is fixed to the carburetor 20, the engine housing 11, or to another suitable portion of the tool, with at least one fastener (or suitable adhesive or other connection apparatus), such that an inlet aperture 44 of the plate 40 is substantially inline with the air inlet 22 of the carburetor 20. In other embodiments discussed below and shown in FIGS. 11-12c, a plate, or dial, 140 may be rotatably mounted to the carburetor 20 and a cup, or outer housing, 160 (or similar structure) may be fixed to the carburetor 20, engine housing 11, or other suitable location of the tool with a plurality of bolts 170 or similar structures.

The plate 40 includes an outer arcuate surface 42 that at least partially surrounds a portion of the carburetor 20. The arcuate surface 42 may include an idle adjust aperture 53, which provides a path for the user to access an adjustment screw in the carburetor 20, which modifies the amount of fuel that flows through the carburetor when the engine is idling to just maintain the combustion cycle self sustaining. In embodiments where the carburetor includes different structures to adjust the idle speed of the engine 10, the idle adjust aperture 53 may be provided in a different portion of the plate 40 as necessary for proper operation of and access to the idle adjustment feature.

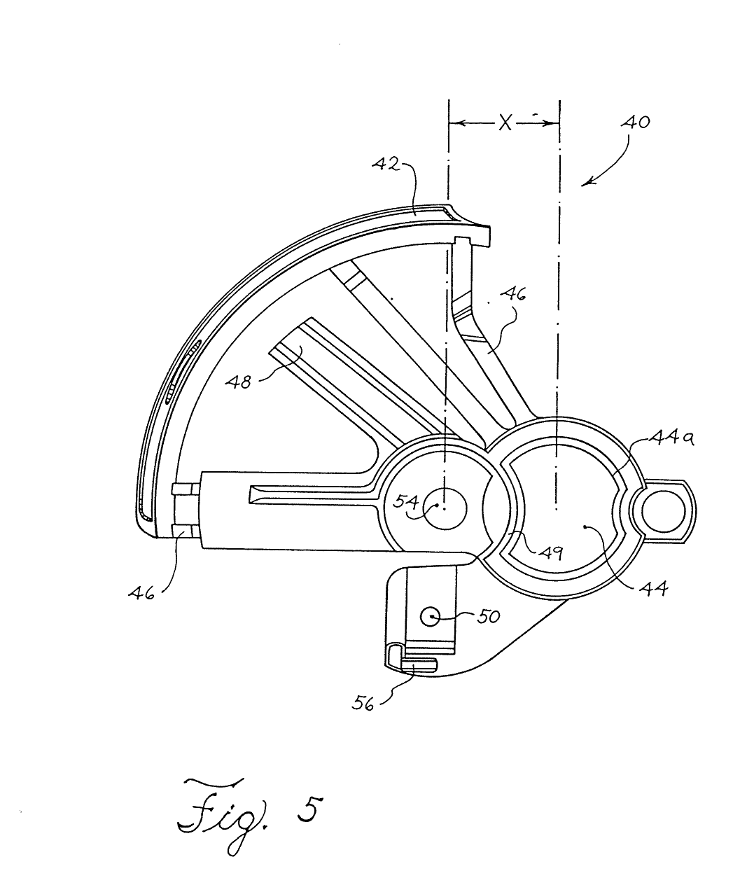

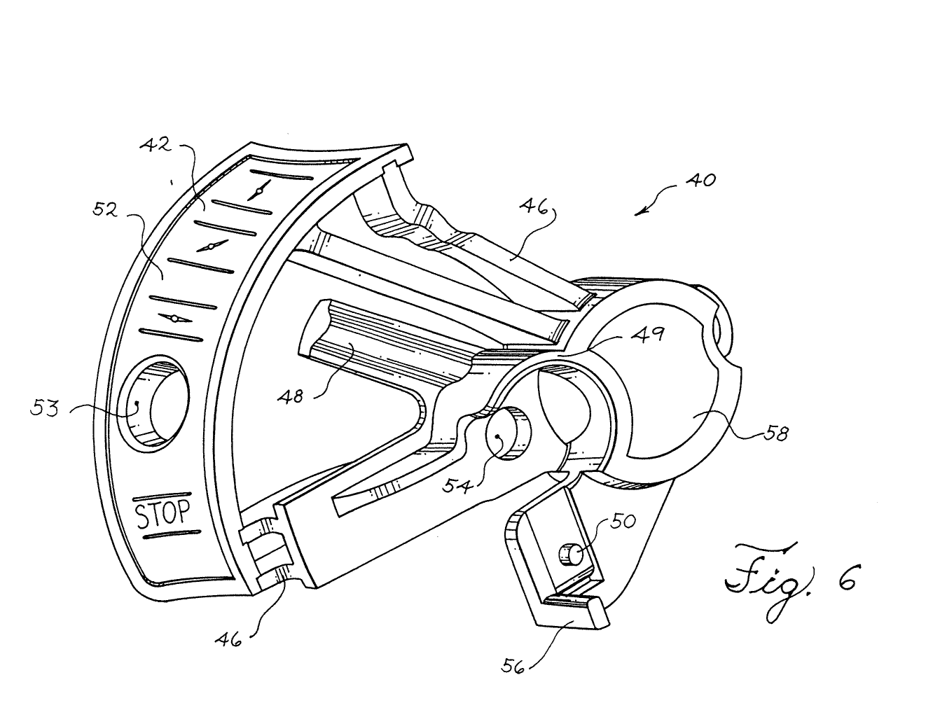

The arcuate surface 42 additionally includes a scale 52 that provides a visual indication of the status of the rotatable choke 30. Specifically, the scale 52 may provide markings that identify whether the choke 30 is in Full Choke, Half Choke, or Run positions (FIGS. 8, 9, and 10, respectively). In embodiments discussed below that include the Stop position, the scale 52 additionally identifies this position. The scale 52 is calibrated with a pointer 72 that is disposed on the dial 60. The scale 52 may indicate the status of the choke 30 with words, numbers or fractions, or pictorially (as shown in FIGS. 1 and 6). The pictorial representation of the choke position shows the theoretical position of a conventional choke plate that is rotatably disposed within the carburetor and often remotely controlled by a mechanical linkage to alter the amount of air flowing through the carburetor, which is a choke design that is well known to those of ordinary skill in the art. The arcuate surface 52 is supported by a plurality of ribs 46 that radially extend from a central portion of the plate 40. The central portion of the plate 40 additionally includes a bolt aperture 54 that provides a hole for a bolt 78 to extend through the plate 40 that rotatably connects the dial 60 to the carburetor 20. The central portion of the plate 40 may additionally include a turret 49 that longitudinally extends from the plate 40 and aids in rotationally supporting the dial 60 around the plate 40.

The plate 40 includes an inlet aperture 44 that is inline with the carburetor inlet 22 when the plate 40 is fixed to the carburetor 20. The inlet aperture 44 provides a directed flow path into the carburetor 20, and substantially prevents air from entering the carburetor 20 from other paths. The inlet aperture 44 supports an air filter 58 that is disposed within the inlet aperture 44 and may rest on a ledge 44a defined within the inlet aperture 44. The air filter 58 mechanically and/or chemically filters air entering the carburetor 20 to minimize the amount of impurities that enter the combustion chamber, for maintaining cleanliness within the combustion chamber and inlet and exhaust flow paths, thereby maximizing the efficiency and life of the engine 10. In other embodiments, the air filter 58 may be a wire mesh or similar structure that is integrally or monolithically formed with the plate 40 to mechanically and/or chemically filter the air entering the carburetor 20.

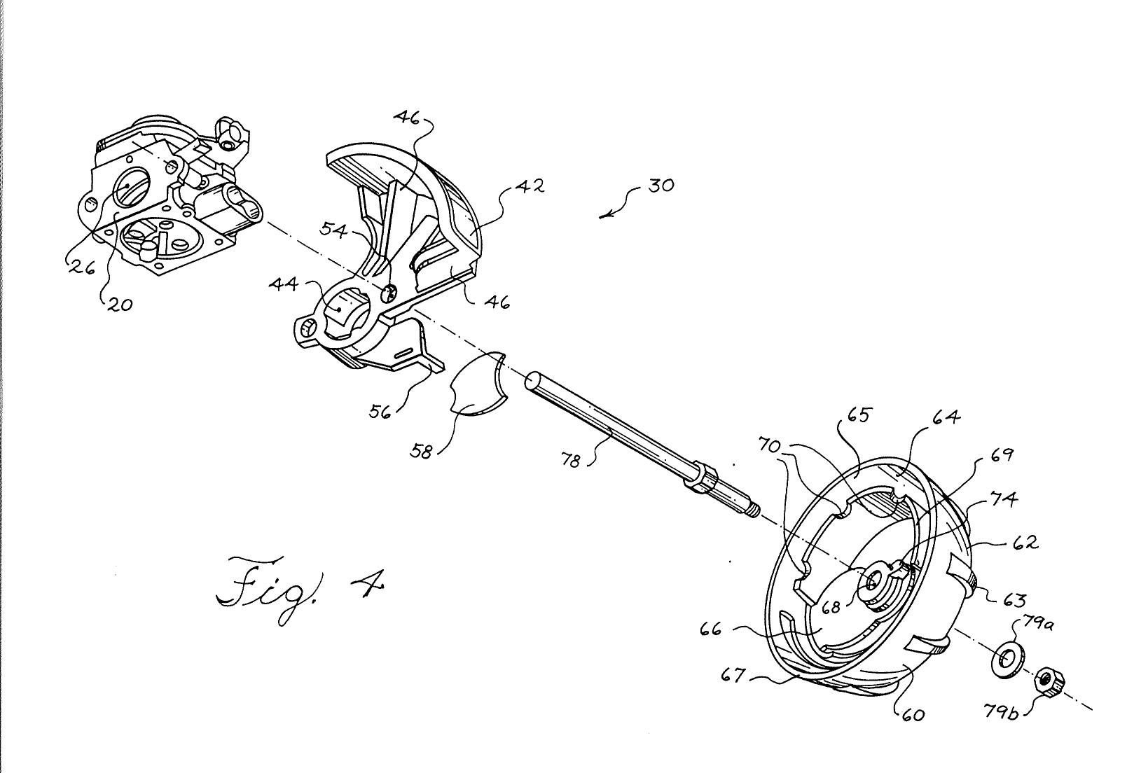

The bolt aperture 54 is offset from the inlet aperture 44, with the distance between the center of the bolt aperture 54 and the center of the inlet aperture shown as X in FIG. 5. The radial distance X is preferably large enough to provide for sufficient supporting structure between the bolt aperture 54 and the side surface of the inlet aperture 44 for sufficient mechanical strength, while minimizing the radius of the plate 40 to minimize the overall size and weight of the choke 30. The distance X and the size and shape of the inlet aperture is determinative of the size, shape, and location of the raised surface 66 of the dial 60, discussed below. The plate 40 may include a finger 56 that extends longitudinally from the plate 40 and is engageable with a plurality of limit stops 76 on the dial 60 to define the range of the potential rotation of the dial 60 with respect to the plate 40 and the carburetor 20.

The plate 40 additionally may include a detent 48 that is fixed to the plate 40 and engageable with a recess 70 or similar structure on the rotatable dial 60. The engagement between the detent 48 and the corresponding recess 70 allows for the dial 60 to be releasably held or fixed in specific predetermined positions with respect to the plate 40 (and the inlet aperture 44), and provides the user with a tactile indication that the dial 60 is in one of the predetermined positions as the detent 48 encounters and then engages the corresponding recess 70 on the dial 60. The releasable engagement between the detent 48 and one of the plurality of recesses 70 additionally provides a releasable mechanical “hold” on the choke 30 to urge the dial 60 into one of the predefined orientations with respect to the plate 40. Accordingly, the user is provided with two independent indications of the choke 30 position between the visual position indication provided by the scale 52 and the pointer 72 and the tactile indication provided by the engagement between the detent 48 and the recesses 70.

The dial 60 is best shown in FIGS. 3, 4, and 7. The dial 60 is formed with an external, or outer, surface 62 and an internal surface 64. The external surface 62 may be generally convex and the internal surface 64 may be generally concave. The dial 60 includes a lip 67 that forms the edge of the dial 60 between the external and internal surfaces 62, 64. The dial 60 may be generally cup-shaped. The external surface 62 of the dial 60 may include a plurality of projections 63 that extend longitudinally and radially from the dial 60, which provides a surface for the user to easily hold and rotate the dial 60 to minimize slippage. The internal surface 64 of the dial 60 may include substantially arcuate side portions 65 and a substantially flat central portion 65a. The internal surface 64 of the dial 60 further includes a raised surface 66 that extends from the central portion 65a toward the lip 67 of the dial 60. The raised surface 66 is substantially parallel to the central portion 65a and is between the lip 67 and the central portion 65a. Specifically, the raised surface 66 extends from the central portion 65a a suitable distance to allow for sliding contact between the raised surface 66 on the dial 60 and the portion of the plate 40 that defines the inlet aperture 44 as the dial 60 rotates with respect to the plate 40.

While the dial 60 is described and shown herein with a conventional cup shape, in other embodiments the dial 60 may be formed with varying geometries. For example, the dial 60 may be a structure with straight edges and planar sides. Alternatively, the dial 60 may be any different type of geometric structure that can be directly rotated about the plate 40 by the user and includes structure to selectively close or block the inlet aperture 44 of the plate 40 based on the position of the dial 60 with respect to the plate 40.

An arcuate ledge 69 longitudinally extends from the central portion 65a toward the lip 67 and includes a plurality of recesses 70 defined therein. The plurality of recesses 70 are engageable by the detent 48 on the plate 40 when the choke 30 is one of the plurality of predetermined positions between the dial 60 and the plate 40.

The dial 60 further includes two limit stops 76 that extend from the side portion 65 and the central portion 65a. As discussed above, the limit stops 76 are engageable by the finger 56 that longitudinally extends from the plate 40 and the contact between the finger 56 and the limit stops 76 defines the range of potential rotation of the dial 60 with respect to the plate 40.

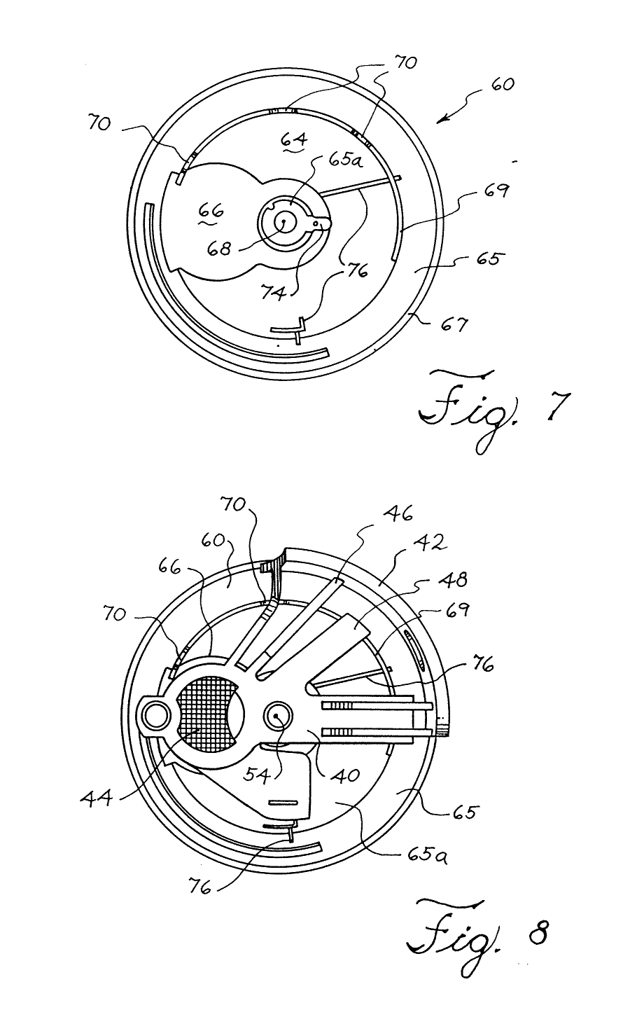

The dial 60 is rotatably mounted on the carburetor 20 with a bolt 78 that extends through a bolt aperture 54. When mounted to the carburetor 20, the arcuate surface 65 of the dial 60 encloses or surrounds a portion of the plate 40 and differing amounts of the inlet aperture 44 are selectively blocked by the raised surface 66 depending on the rotational position of the dial 60. Specifically, when the dial 60 is rotated to the Full Choke position (FIG. 8), the raised surface 66 makes sliding contact with the portion of the plate 40 that defines the inlet aperture 44, and air is substantially entirely blocked by the raised surface 66 from flowing through the air filter 58 and into the carburetor 20. The dial 60 may be rotated with respect to the plate 40 until only a portion of the inlet aperture 44 is blocked by the raised surface 66, which allows air flow through the inlet aperture 44 and into the carburetor 20, i.e. the Half Choke position (FIG. 9).

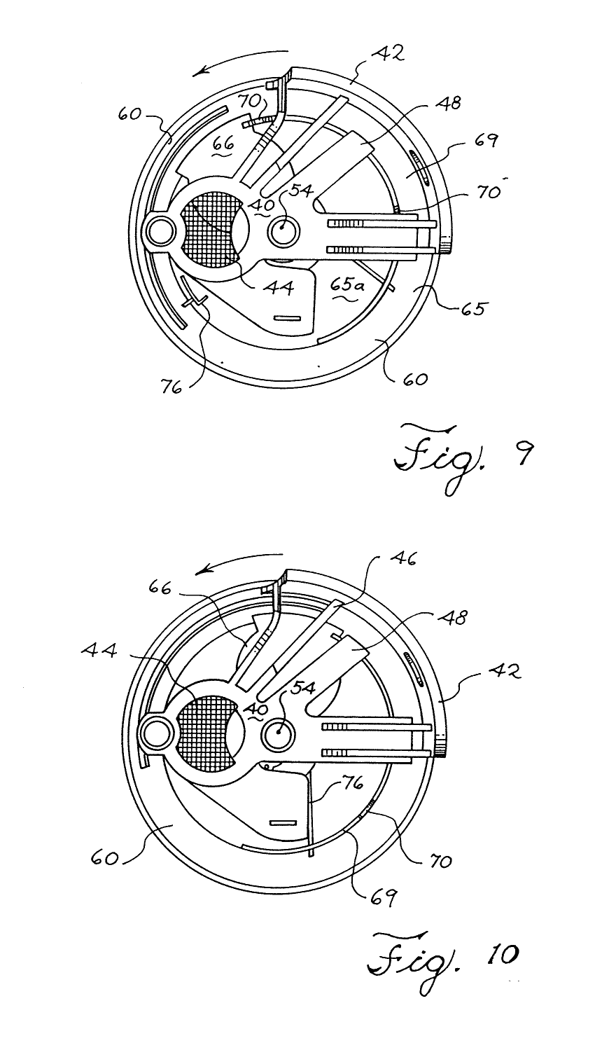

When the choke 30 is in the Half Choke position (and the Run position) air flows around the external surface 62 and the lip 67 of the dial 60. Air then flows past the arcuate inner surface 64 and into the inlet aperture 44 and to the carburetor 20. The dial 60 can then be rotated to the Run position (FIG. 10), where the inlet aperture 44 on the plate 40 no longer contacts the raised surface 66 of the dial 60, and the entire area of the inlet aperture 44 is exposed to allow maximum air flow through the carburetor 20.

As shown in FIGS. 11-12c, an alternate choke 130 is provided. The choke 130 encloses a portion of the carburetor 20 and selectively opens and closes the air inlet 22 to the carburetor 20. The rotatable choke 130 includes a rotatable plate, or dial, 140 that rotates about the carburetor 20 and a cup, or outer housing, 160 that is fixed to the carburetor 20 or other portions of the engine housing 11. As shown in FIG. 11, the plate 140 neighbors the inlet 22 of the carburetor 20 and the cup 160 is fixedly provided on the opposite side of the plate 140 from the carburetor 20.

The plate 140 is rotatable about a bolt 170 that extends through a hole 146 in the choke plate and further extends through a bolt hole 164 in the cup 160. The bolt 170 is fixed to either the carburetor 20 or another suitable structure of the engine 10. A second bolt 171 also extends from the carburetor 20 or another suitable structure of the engine 10 and extends through a second bolt hole 164 in the cup 160 to fix the cup 160 with respect to the carburetor 20. The plate 140 is sized and shaped to allow for rotation about the bolt hole 146 without contacting the second bolt 171.

The plate 140 includes a choke aperture 142 that is defined within the plate 140 and is located a radial distance Z from the rotational axis of the plate 140 that is collinear with a hole 146 defined in the plate 140. The plate 140 includes an operator 144 that extends radially from the outer circumference of the plate 140 and provides structure for the user to manipulate to rotate the plate 140 with respect the carburetor 20 and the cup 160. An air filter 148 may be provided with the plate 140 to mechanically and/or chemically filter air entering the carburetor 20. The air filter 148 may be integrally or monolithically formed with the plate 140 or the air filter 148 may be a separate component from the plate 140 and assembled with the plate 140.

The cup 160 includes a through aperture 162 that is substantially collinear with the inlet 22 of the carburetor 20 and allows air to flow through the cup 160 to the plate 140. The cup 160 additionally includes a plurality of recesses 166 that are provided on the outer circumference of the cup 160 and are capable of receiving the operator 144 of the plate 140 to retain the plate 140 in the selected position with respect to the carburetor 20 and the cup 160. In some embodiments, three recesses 166 are provided to retain the plate 140 in the Full Choke, Half Choke, and Run positions. In some embodiments, and air filter (not shown) may be integrally or monolithically formed in the through aperture 162 of the cup 160 to mechanically and/or chemically filter air flowing through the cup 160 prior to entering the carburetor 20. The air filter on the cup 160 may be in addition to or instead of the air filter 148 on the plate 140.

The choke aperture 142 of the plate 140 is sized and located to selectively alter the volume of air that can flow through the plate 140 (after flowing through the through aperture 162 of the cup 160) to the carburetor 20. Specifically, the choke aperture 142 is sized and located to substantially prevent air from flowing from the cup 160 into the carburetor 20 when the plate 140 is in the Full Choke position (FIG. 12a). The choke aperture 142 partially exposes the inlet 22 of the carburetor 20 to allow a fraction of the total possible air flow through the cup 160 to enter the carburetor 20 when the plate 140 is in the Half Choke position (FIG. 12b). The choke aperture 142 fully exposes the inlet 22 of the carburetor 20 to allow substantially all of the total possible air flow through the cup 160 to enter the carburetor 20 when the plate 140 is in the Run position (FIG. 12c). The operator 144 of the plate 140 biasingly enters one of the plurality of recesses 166 to retain the plate 140 in the selected operational position and allow the user to rotate the plate 140 during startup of the engine 10, to allow the suitable amount of air to the carburetor 20 for proper engine operation.

As best shown in FIGS. 4-7, the choke 30 may include another position, i.e. the Stop position that causes the operating internal combustion engine 10 to stop. Specifically, the dial 60 of the choke 30 may be rotated to another position with respect to the plate 40 where current flow to the spark plug 14a is dramatically attenuated or eliminated, preventing additional fuel combustion and additional operation of the internal combustion engine 10. The Stop position may be reached by rotating the dial 60 from the Run position in the opposite rotational direction from the Half Choke and Full Choke positions.

The plate 40 may include a first electrical contact 50 that is electrically connected with the spark plug 14a and the associated current source for the spark plug 14a, such as a generator or magneto. The dial 60 includes a corresponding electrical contact 74 (best shown in FIG. 7) that is provided in the vicinity of the central bolt aperture 68 that is engageable with the first electrical contact 50 when the dial 60 is rotated to the Stop position. The second electrical contact 74 is electrically connected to the central aperture 68, which provides electrical contact with the bolt 78 that extends through the central bolt aperture 68. The bolt 78 is received within the carburetor, which is in electrical connection with the engine housing 11.

During normal operation (i.e. when the choke 30 is not in the Stop position), current flows from the current source to the spark plug 14a at specific times during the cyclic operation of the engine 10 to provide an electrical spark within the combustion chamber depending on the rotational speed of the internal combustion engine 10. When the dial 60 is rotated to the Stop position, the first and second electrical contacts 50, 74 on the plate and dial 40, 60, respectively, make electrical contact with each other. This electrical contact provides the spark plug circuit with a low resistance path to the grounded housing, which significantly attenuates or prevents current from reaching the spark plug 14a, inhibiting spark plug 14a ignition and preventing the fuel/air mixture from combusting with the combustion chamber. Eventually, the angular momentum of the crankshaft will be overcome due to frictional or other system energy losses within the power tool, and the engine will no longer provide torque to rotate the output, regardless of the position of the throttle system and the choke 30. Because the spark plug circuit is grounded, the internal combustion engine 10 cannot be restarted until the choke 30 is rotated away from the Stop position. In embodiments with the on/off switch 180, discussed below, the Stop function may not be provided on the dial 60.

In other embodiments, the internal combustion engine 10 may be provided with an on/off switch 180 (FIG. 1) or similar type of switch that performs the same function as the Stop function described above. The on/off switch 180 may be a two position switch that is wired to connect the spark plug 14a and the associate circuit to the grounded housing when the switch 180 is in the off position. In some embodiments the on/off switch 180 may be a rocking toggle switch that is biased to the on position. As discussed above, electrically connecting the spark plug 14a to the grounded housing inhibits spark plug 14a ignition and therefore prevents further operation of engine 10. When the switch 180 is in the on position, the electrical connection between the spark plug 14a and the grounded housing is opened, allowing the spark plug 14a to cyclically emit a spark for continued engine operation.

In embodiments with the Stop function on the dial 60, the limit stops 76 may be defined within the dial 60 to allow the dial 60 to be rotated past the Run position to the Stop position. Further, in embodiments with the Stop function, a recess 70 may be defined within the dial 60 that is engageable with the detent 48 on the plate 40 to provide the user a tactile indication that the choke 30 is in the Stop position, as well as a releasable mechanical “hold” to urge the choke 30 to be maintained in the Stop position. Further, the Stop function may be provided in embodiments where the plate 140 rotates about a cup 160.

It is apparent that apparatus incorporating modifications and variations to the choke 30, 130 or carburetor 30 of the present invention described above will be obvious to one skilled in the art. Inasmuch as the foregoing disclosure is intended to describe the present invention the above description should not be construed to limit the present invention but should be construed to include any obvious variations and should be limited only by the spirit and scope of the following claims. It is therefore intended that the foregoing detailed description be regarded as illustrative rather than limiting, and that it should be understood that it is the following claims, including all equivalents, that are intended to define the spirit and scope of this invention.

What is claimed:

1. A carburetor comprising:
a housing defining an air intake;
a first member fixed to the housing, comprising an inlet aperture in fluid communication with the air intake; and
a second member rotatably mounted to the housing, wherein the second member substantially prevents air flow to the inlet aperture in a first position with respect to the first member, and the second member exposes the inlet aperture to air flow in a second position with respect to the first member.

2. The carburetor of claim 1, wherein the second member further comprises an intermediate position between the first and second positions where the second member exposes a portion of the inlet aperture and blocks the remainder of the inlet aperture.

3. The carburetor of claim 1, wherein the first member further comprises a detent that is engageable with one of a plurality of recesses defined in the second member to provide a tactile notification of the position of the second member with respect to the first member.

4. The carburetor of claim 1, wherein an air filter is provided in the inlet aperture on the first member.

5. The carburetor of claim 1, wherein the second member is rotatably mounted in an offset manner to a center of the inlet aperture.

6. The carburetor of claim 1, wherein the second member comprises an arcuate surface that at least partially surrounds a portion of the first member and faces the first member.

7. The carburetor of claim 6, wherein the second member further comprises a raised surface that selectively prevents air flow to the inlet aperture.

8. The carburetor of claim 7, wherein rotation of the second member with respect to the first member alters the position of the raised surface with respect to the inlet aperture.

9. The carburetor of claim 1, wherein the second member is positioned such that air flow through the air inlet aperture flows substantially past a lip of the second member and past an interior surface of the second member prior to entering the inlet aperture.

10. The carburetor of claim 1, wherein an exterior surface of the second member has at least one projection extending outward from the second member.

11. The carburetor of claim 1, further comprising a third position of the second member with respect to the first member, wherein an electrically conductive plate disposed on the second member contacts a corresponding electrically conductive plate disposed on the first member when the second member is in the third position.

12. The carburetor of claim 11, wherein the conductive plate on the first member is electrically connected to a spark plug to inhibit spark plug ignition when the second member is in the third position.

13. The carburetor of claim 1, wherein the first member further comprises an indicator surface and the second member further comprises a pointer calibrated with the indicator surface to provide an indication of the inlet aperture position.

14. The carburetor of claim 1, wherein the first member is a plate fixed to the housing and the second member is a cup rotatably mounted to the housing.

15. The carburetor of claim 1, wherein the second member surrounds a portion of the first member.

16. The carburetor of claim 1, wherein the second member neighbors the air intake of the housing and the first member is provided on the opposite side of the second member from the air intake of the housing.

17. The carburetor of claim 1, wherein the first member neighbors the air intake of the housing and the second member is provided on the opposite side of the first member from the air intake of the housing.

18. The carburetor of claim 1, wherein the first member is multiple components rigidly attached together.

19. A choke for use with an internal combustion engine comprising:
a first member mounted to the engine, comprising an inlet aperture in fluid communication with an engine air intake; and
a second member rotatably mounted to the engine and at least partially surrounding at least a portion of the first member and inlet aperture, wherein rotation of the second member with respect to the first member selectively blocks air flow to the inlet aperture.

20. The choke of claim 19, wherein the first member comprises a plate and the second member comprises a dial.

21. The choke of claim 19, wherein the second member comprises a raised surface in proximity to the inlet aperture.

22. The choke of claim 19, wherein the second member comprises an interior surface that at least partially surrounds a portion of the first member, and selectively blocks varying portions of the inlet aperture based on the position of the second member.

23. The choke of claim 19, wherein the second member and the first member comprise a means to identify the operational position of the choke.

24. A carburetor for an internal combustion engine comprising:
a housing defining an air intake;
a first member mounted to the housing, comprising an air inlet aperture in fluid communication with the air intake, and a first electrical contact in electrical communication with a spark plug within the engine; and
a second member rotatably mounted to the housing and comprising a second electrical contact, wherein the second member is rotatable to a position wherein the first and second contacts are electrically connected.

25. The carburetor of claim 24, wherein an electrical connection between the first and second contacts inhibits spark plug ignition.

26. The carburetor of claim 24, wherein the second electrical contact is electrically connected to a bolt around which the second member rotates to electrically connect the spark plug to ground.
